(19) United States
(12) Patent Application Publication
(10) Pub. No.: US 2026/0243569 A1
(43) Pub. Date: Aug. 20, 2026

(54) METHOD FOR NOISE-REDUCED OPERATION OF ROTATION RATE SENSORS IN THE PRESENCE OF HIGH-FREQUENCY VIBRATIONS, AND CORRESPONDINGLY NOISE-REDUCED ROTATION RATE SENSOR

(71) Applicant: Robert Bosch GmbH, Stuttgart (DE)

(72) Inventors: Johannes Classen, Reutlingen (DE); Steven Kehrberg, Schoenaich (DE); Britta Vincon, Sonnenbuehl-Genkingen (DE); Gerhard Lammel, Tuebingen (DE); Ralf Schellin, Reutlingen (DE)

(21) Appl. No.: 19/533,761

(22) Filed: Feb. 9, 2026

(30) Foreign Application Priority Data
Feb. 20, 2025 (DE) 10 2025 106 549.7

(51) Int. Cl. G01C 19/5762; G01C 19/00

(52) U.S. Cl. CPC G01C 19/5762; G01C 19/005

(57) ABSTRACT

A rotation rate sensor. The rotation rate sensor has a drive mass element which is arranged above a surface of a substrate and can be driven by a drive device to oscillate along a first axis, a detection mass element which can be deflected along a second axis by the action of a Coriolis force, and a detection device by which the deflection of the detection mass element along the second axis can be detected, wherein the second axis runs perpendicularly to the first axis. The rotation rate sensor is characterized by a device for frequency-shifting an interference mode of the rotation rate sensor to reduce noise. A method for low-noise operation of a rotation rate sensor is also described.

### CROSS REFERENCE

The present application claims the benefit under 35 U.S.C. § 119 of Germany Patent Application No. 10 2025 106 549.7 filed on Feb. 20, 2025, which is expressly incorporated herein by reference in its entirety.

### FIELD

The present disclosure relates to a noise-reduced rotation rate sensor and to a method for noise-reduced operation of rotation rate sensors in the presence of high-frequency vibrations.

### BACKGROUND INFORMATION

Rotation rate sensors are used to determine the rotational speed of bodies and are available in various designs. Such rotation rate sensors are used, for example, in numerous applications in the automotive and consumer electronics sectors in the form of micromechanical sensors for measuring rotation rates.

Of importance here is the use of rotation rate sensors or three-axis acceleration and rotation rate sensors, so-called Inertial Measurement Units (IMUs), in smartphones to measure movements, for example to adjust the orientation of objects on the screen based on the measured rotational movement when navigating or playing games.

Micromechanical rotation rate sensors used in consumer electronics are based almost exclusively on the principle of the Coriolis vibration gyroscope, in which a moving drive mass is deflected perpendicularly to the direction of the drive movement by the Coriolis force when rotations occur. A lateral deflection movement is detected in most cases using capacitive electrodes. However, other sensing principles such as piezoresistive or piezoelectric detection methods are also possible.

Germany Patent Application No. DE 10 2006 047 135 A1 describes a rotation rate sensor with a drive mass element which is arranged above a surface of a substrate and can be driven by a drive device to oscillate along a first axis which runs along the surface. The rotation rate sensor contains a detection mass element that can be deflected along a second axis by the action of a Coriolis force, and a detection device by which the deflection of the detection mass element along the second axis can be detected. The rotation rate sensor is characterized in that the second axis runs perpendicularly to the surface.

The related art shows that micromechanical rotation rate sensors have a complex structure with numerous spring and mass elements. For the operation of a rotation rate sensor, only the drive mode and one detection mode for each axis of rotation are of direct functional importance; that is, one detection mode for a single-axis rotation rate sensor, two detection modes for a two-axis rotation rate sensor, and three detection modes for a three-axis rotation rate sensor. However, every real rotation rate sensor structure has countless other eigenmodes, which are referred to below as parasitic modes or interference modes. These parasitic modes can be resonantly excited under unfavorable circumstances when externally imposed vibrations occur. This can result in large deflection amplitudes of structural elements such as masses or springs. In the case of very large parasitic deflections of the interference modes, or if structural elements such as masses or springs mechanically reach a limit due to vibration, significant errors in the signal path can result in greatly increased noise or offset jumps.

Modern consumer electronics devices are usually battery-powered and therefore need to be charged regularly. During the charging process, electrical frequencies of several hundred kilohertz are used; for example, 87-205 kHz for inductive charging according to the Qi standard, while even higher frequencies are used for wired charging. The charging electronics of smartphones have capacitors on the circuit board. The capacitors expand slightly when a voltage is applied or contract when the voltage is reduced, according to a piezoelectric effect. Accordingly, a high-frequency charging process leads to the excitation of vibrations in the capacitor and the entire circuit board at the charging frequency. If a rotation rate sensor is mounted on the same circuit board, a parasitic mode of the rotation rate sensor which is closely adjacent to the charging frequency can be resonantly excited and can generate significant interference in the signal path of the rotation rate sensor in the form of greatly increased noise or offset jumps.

It is possible in the design of the rotation rate sensor to aim to push potentially critical parasitic modes out of certain frequency ranges by suitable design measures, for example by optimized arrangement of masses and/or springs. However, the critical frequency ranges for the sensor design are not always known in advance, as they may differ for different device manufacturers or device generations. Furthermore, micromechanical sensors have certain manufacturing tolerances, which have the result that the frequency position of the parasitic modes is not identical for all rotation rate sensors of the same type, but is subject to fluctuations.

Furthermore, the charging frequency can also fluctuate depending on the individual device. Therefore, it is not unlikely that, while a large proportion of rotation rate sensors show no interference during the charging process, individual units may have an unfavorable position of the relevant parasitic mode and may therefore be disturbed by the vibrations generated during charging.

An object of the present disclosure is to prevent, or at least reduce, increased noise and offset shifts of rotation rate sensors during the charging process of the device containing the rotation rate sensors.

### SUMMARY

Embodiments of the present disclosure may achieve this object with a noise-reduced rotation rate sensor and a method for noise-reduced operation of rotation rate sensors in the presence of high-frequency oscillations, according to certain features of the present disclosure.

Accordingly, in a first aspect, the present disclosure provides a rotation rate sensor with at least one drive mass element which is arranged above a surface of a substrate and can be driven by a drive device to oscillate along a first axis, at least one detection mass element which can be deflected along a second axis by the action of a Coriolis force, and at least one detection device by which the deflection of the detection mass element along the second axis can be detected, wherein the second axis runs perpendicularly to the first axis. The rotation rate sensor is characterized by a device for frequency-shifting an interference mode of the rotation rate sensor to reduce noise or to reduce offset jumps.

In a second aspect, the present disclosure provides a method for operating a rotation rate sensor, in particular a rotation rate sensor according to the first aspect, wherein the rotation rate sensor is micromechanically constructed and a Coriolis element is excited to oscillate along a first direction and wherein the Coriolis deflection of the Coriolis element along a second direction is detected by means of the detection device. The method is characterized in that noise in the rotation rate sensor is measured and in that, in the case of increased noise, a frequency shift of an interference mode is caused by a change in operating parameters.

According to the present disclosure, if significant noise or offset jumps occur in the signal path of the rotation rate sensor during the charging process of the consumer electronics device, the frequency position of one or more relevant parasitic modes in the signal path of the rotation rate sensor is shifted by suitable measures in such a way that they are no longer or only weakly excited by the charging vibrations. Possible measures according to the present disclosure include changes to the local temperature of the rotation rate sensor, changes to the drive amplitude of the rotation rate sensor, and electrostatic tuning to shift the frequency of interference modes which occur in particular during the charging process of an electronic device containing the rotation rate sensor. A combination of the aforementioned changes to the operating parameters of the rotation rate sensor is also conceivable. According to the present disclosure, the operating point of the rotation rate sensor is shifted to avoid interference with the rotation rate sensor.

The present disclosure offers the advantage that rotation rate sensors can perform their function without interference even during the charging process of a smartphone containing them or under corresponding electrical boundary conditions of a consumer electronics device.

Further advantages are disclosed herein.

Preferably, two drive mass elements, two drive devices and two detection mass elements as well as two detection devices are provided in a symmetrical structure. In this way, an antiparallel movement of the detection mass elements can take place in order to suppress interfering influences caused by linear accelerations.

In a first embodiment of the rotation rate sensor according to the present disclosure, the device for frequency-shifting an interference mode is designed as a heating element.

In a preferred embodiment of the rotation rate sensor, a housing accommodates the movable mass elements which are designed as a microelectromechanical structure (MEMS) with an associated integrated switching element.

Furthermore, the heating element can be provided as a resistance line, preferably in a meandering shape, in a metal plane of a substrate of the housing. This allows for good thermal coupling, so that relatively low heating power levels lead to a temperature increase in the MEMS structure.

In a preferred embodiment of the rotation rate sensor according to the present disclosure, the heating element is provided in or on the integrated switching element. This allows for very effective transport into the MEMS structure.

In another embodiment of the rotation rate sensor according to the present disclosure, the integrated switching element is designed as an application-specific integrated circuit (ASIC) and the heating element is formed in a metal layer, preferably in an upper metal layer of the integrated switching element. The resistance line is preferably designed as a resistance meander. Here, too, the very effective heat transport provides an advantage.

In another embodiment of the rotation rate sensor according to the present disclosure, the heating element is provided on a substrate of the microelectromechanical structure (MEMS) or a MEMS chip.

Preferably, the heating element is provided in a wiring plane below a movable structure of the rotation rate sensor. This allows the heating element to be supplied with voltage or current in a relatively simple way via bonding wires.

In yet a further embodiment of the rotation rate sensor according to the present disclosure, the heating element is provided in a cap of the microelectromechanical (MEMS) structure. Preferably, an integrated switching element designed as a functional application-specific integrated circuit (ASIC) is used as the MEMS cap.

In the rotation rate sensor according to the present disclosure, the movable mass elements can be designed as a microelectromechanical structure (MEMS), an integrated switching element can be assigned to the microelectromechanical structure (MEMS) as a cap, and the heating element can be provided in the cap of the microelectromechanical structure (MEMS).

Preferably, the movable mass elements designed as a microelectromechanical structure (MEMS) are connected to an integrated switching element as a cap via a wafer bonding process, and the heating element is provided in the cap of the microelectromechanical structure (MEMS).

The movable micromechanical structure or MEMS structure of the rotation rate sensor itself is used as a further exemplary embodiment of the heating element in the first embodiment of the rotation rate sensor according to the present disclosure. However, this requires that sub-regions of the mechanically interconnected structure can be galvanically isolated from each other. Then, in a region galvanically separated from the main region of the MEMS structure, at least two mechanical and electrical anchors can be arranged and subjected to a potential difference. A current then flows through sub-regions of springs and mass elements, which leads to a heating of the MEMS structure due to the finite conductivity of the micromechanical functional layer (which typically consists of doped polycrystalline silicon or single-crystal silicon). Advantageously, this heating is very local, and so very little energy is required to achieve a sufficient temperature increase in the MEMS structure.

In a second example embodiment of the rotation rate sensor according to the present disclosure, the structure is micromechanical and the detection devices designed as detection electrodes form a plate capacitor, wherein a voltage between the detection electrodes and the moving detection mass elements can be varied to adjust an electrostatic spring softening.

In a micromechanically constructed rotation rate sensor, existing electrodes not used for rotation rate detection or additional electrodes can also form the plate capacitor, wherein a voltage between the electrodes and the moving detection mass elements can be varied to adjust an electrostatic spring softening.

Within the scope of the present disclosure, the terms microelectromechanical or micromechanical structure, micromechanical or microelectromechanical element, and MEMS chip or MEMS structure are used synonymously.

In a first example embodiment of the method for operating a rotation rate sensor, the frequency shift of an interference mode is caused by a local temperature increase.

In a second example embodiment of the method for operating a rotation rate sensor, the frequency shift of an interference mode is caused by a change in the drive amplitude.

Finally, in a third example embodiment of the method for operating a rotation rate sensor, the frequency shift of an interference mode is caused by an electrostatic spring softening.

The present disclosure is explained in more detail below with reference to exemplary embodiments in connection with the accompanying drawings, which are partially simplified and drawn to different scales.

### BRIEF DESCRIPTION OF THE DRAWINGS

FIG. 1A shows a schematic diagram of a rotation rate sensor according to the related art in top view.

FIG. 1B shows a section of the rotation rate sensor along the line A-B in FIG. 1A.

FIGS. 2A and 2B shows a representation of typical arrangements of micromechanical MEMS rotation rate sensors.

FIGS. 3A and 3B shows a first example embodiment of a first rotation rate sensor according to the present disclosure based on a correspondingly designed MEMS chip.

FIG. 4 shows a first example embodiment of the method according to the present disclosure for operating rotation rate sensors based on a flowchart.

FIGS. 5A and 5B show a second exemplary embodiment of a heating element of the rotation rate sensor according to the present disclosure based on a correspondingly designed MEMS chip.

FIGS. 6A and 6B show a representation of micromechanical MEMS chips of a third exemplary embodiment of a heating element of the rotation rate sensor according to the present disclosure.

FIGS. 7A and 7B show a representation of micromechanical MEMS chips to illustrate a fourth exemplary embodiment of a heating element of the rotation rate sensor according to the present disclosure.

FIG. 8 shows a flowchart illustrating a second embodiment of a method according to the present disclosure for noise-reduced operation of rotation rate sensors.

FIG. 9 shows a flowchart illustrating a third embodiment of a method according to the present disclosure for noise-reduced operation of rotation rate sensors.

FIG. 10A shows a schematic diagram of a rotation rate sensor according to the present disclosure in top view.

FIG. 10B shows a section of the rotation rate sensor according to FIG. 10A.

### DETAILED DESCRIPTION OF EXAMPLE EMBODIMENTS

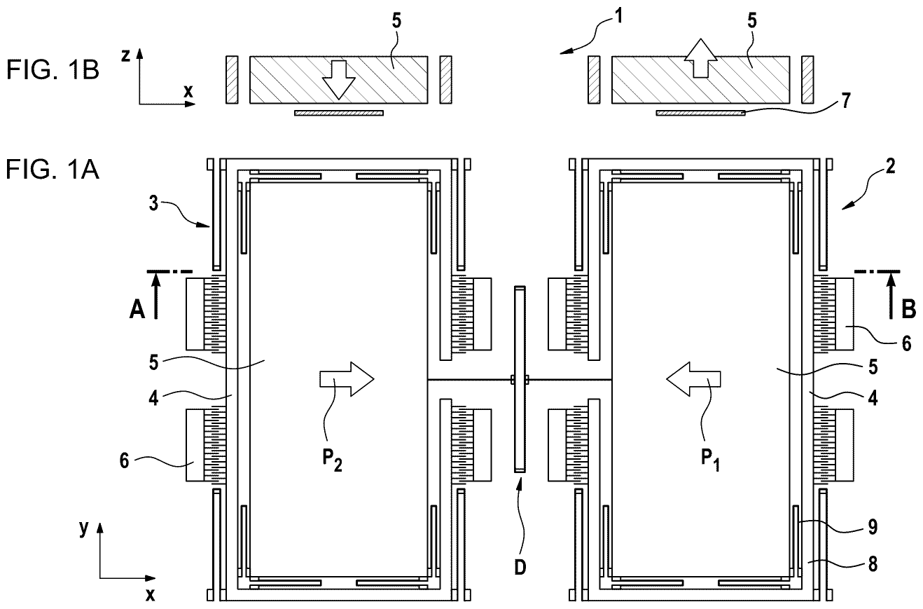

FIG. 1A shows a micromechanical, electrostatically driven and capacitively detecting rotation rate sensor 1 from the related art, designated as a whole by reference sign 1, with two identical structures 2, 3, each with an outer and inner mass element 4, 5, and comb electrodes 6 for drive and for drive detection. Furthermore, each of the structures 2, 3 of the rotation rate sensor 1 has a detection electrode 7; see FIG. 1B. The outer and inner mass elements 4, 5 are set into resonant oscillation by means of control electronics (not shown) via an alternating electrical voltage applied to the comb electrodes 6. The drive movement is antiparallel, i.e. the mass elements 4, 5 of structure 3 oscillate 180° out of phase with the mass elements 4, 5 of structure 2 as indicated by the arrows P1, P2. This suppresses, as effectively as possible, interference caused by linear accelerations acting in phase on the two mass elements 4, 5.

When Coriolis forces occur, caused by rotational movements around the y-axis or an axis of rotation D, the inner mass elements 5 are deflected out of phase perpendicularly to the plane of the MEMS element (plane of the paper in FIG. 1A), i.e. in the z-direction. If the springs 9 arranged on the outside of the drive frame 8 are appropriately dimensioned, the outer mass elements 4 are suspended very rigidly in the detection direction and thus can hardly be deflected. The out-of-phase movement of the inner mass elements 5 can be picked up via suitable interconnection of the capacitive detection electrodes 7 arranged below the inner mass elements 5. Since the Coriolis force is proportional to the speed and the speed of the drive mass elements 4, 5 changes sinusoidally, the detection signal must be demodulated with the frequency of the drive oscillation in order to extract the significantly lower-frequency rotation rate signals.

The structure shown in FIGS. 1A and 1B is to be understood merely as an example illustrating the functioning of a micromechanical rotation rate sensor. However, the present disclosure is by no means limited to this sensor topology. The present disclosure can also be applied to other sensor topologies of rotation rate sensors; these include for example rotation rate sensors of which the drive and detection oscillations run parallel to the chip surface, rotation rate sensors with drive movement perpendicular to the chip surface, multi-axis rotation rate sensors with multiple drive and/or detection oscillation directions, and rotation rate sensors in which drive mass elements and detection mass elements or outer and inner mass elements form common mass elements that can be deflected in both the drive direction and the detection direction.

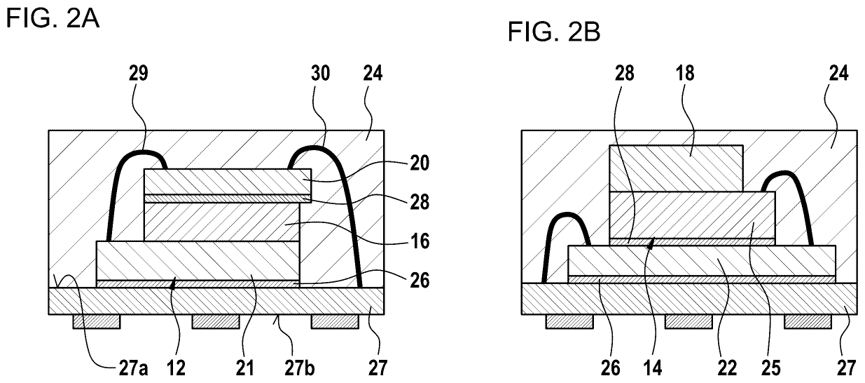

FIGS. 2A and 2B show typical arrangements of micromechanical inertial sensors according to the present disclosure, such as acceleration or rotation rate sensors formed by a discrete MEMS chip 12, 14 with substrate wafer and cap wafer 16, 18 as well as integrated switching elements 20, 22 for control and signal evaluation of the MEMS chip. The integrated switching element 20, 22, designed as an application-specific integrated circuit (ASIC), the MEMS chip 12, 14 and the cap wafer 16, 18 are packaged in an injection-molded housing 24, which can be designed for example as a Land Grid Array (LGA) housing.

According to FIG. 2A, the MEMS chip 12, consisting of the MEMS cap wafer 16 and a MEMS substrate 21 on which functional MEMS structures (not shown) are arranged, is mounted on a housing substrate 27 by means of an adhesive 26, for example a die attach film (DAF). The ASIC 20 is fixed to the MEMS cap wafer 16 of the MEMS chip 12 with a further adhesive 28, for example a DAF. Electrically conductive connections between the MEMS chip 12 and the ASIC 20, as well as between the ASIC 20 and the housing substrate 27, are realized via bonding wires 29, 30 which are conventional. Electrical lines (not shown in FIG. 2A are led from a top side 27a of the housing substrate 27 to a bottom side 27b of the housing substrate 27. FIG. 2B shows an arrangement with fundamentally identical components, but in this case an ASIC 22 is arranged on the housing substrate 27 and bonded with the adhesive 26, and a MEMS chip 14 with its MEMS substrate 25 is glued to the ASIC 22 with the further adhesive 28.

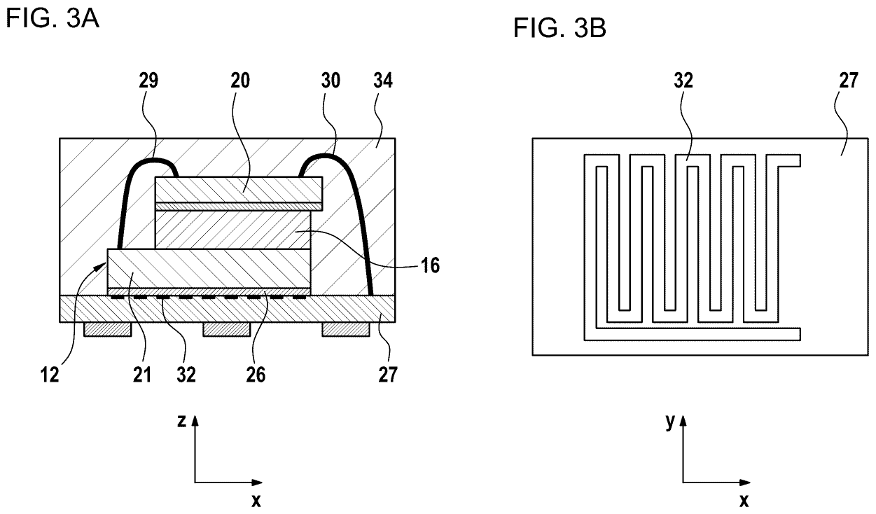

In a first embodiment of the rotation rate sensor according to the present disclosure and the method according to the present disclosure, a heating element designed as a resistance meander 32 is integrated in a metal plane of the housing substrate 27 of an LGA or ball grid array (BGA) injection-molded housing 34, as schematically illustrated in FIGS. 3A and 3B.

FIG. 3A shows the resistance meander 32 in cross section, while FIG. 3B shows a top view of the housing substrate with the resistance meander 32 without MEMS chip 12 and ASIC 20. Since the MEMS chip 12 is directly fixed to the housing substrate 27 by means of the adhesive 26 in this embodiment, the thermal coupling to the heating element 32 is very good, and so even relatively low heating powers lead to a significant increase in the temperature in the MEMS chip 12. The heating element 32 on the housing substrate 27 can either be controlled via dedicated outputs of the ASIC 20 and via two bonding wires 29, 30, or else supplied from an external source via a circuit board and solder contacts of the rotation rate sensor. Since one end of the heating element 32 can in principle be connected to substrate potential, one bonding wire 29 would also be sufficient to control the heating element 32 from the ASIC.

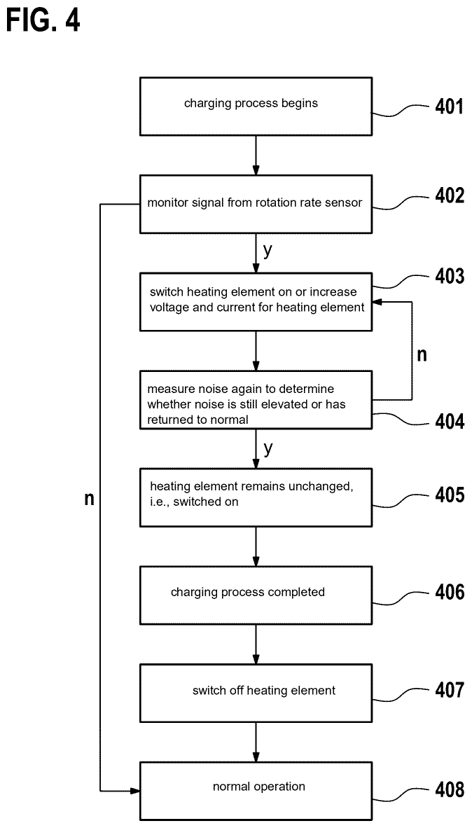

A first embodiment of the method according to the present disclosure for noise-reduced operation of rotation rate sensors in the presence of high-frequency oscillations or vibrations is illustrated by the flowchart in FIG. 4. In a first step 401 the charging process begins, and in the second step 402 a signal from the rotation rate sensor is monitored for noise and/or an offset. The signal monitoring can be performed either via logic integrated into the rotation rate sensor itself, for example a microprocessor with suitable self-monitoring algorithms integrated in an integrated switching element or in the sensor housing, or else via an external host processor such as the main processor of the smartphone in which the rotation rate sensor is located.

If no increased noise is observed during the charging process, the sensor remains in normal operation 408, as shown by the arrow between step 402 and step 408. If the noise is increased or the offset is significantly shifted, in a third step, shown at 403, the heating element 32 is switched on and supplied with a voltage U or a current I, or the voltage U and the current I at the heating element 32 are increased. In a fourth step 404, the noise is measured again to determine whether the noise is still elevated or has returned to normal. If the application of the voltage U or the current I has led to the termination of the signal interference, the heating element 32 remains unchanged, i.e. switched on, in a fifth step 405. If the noise remains unchanged or is only slightly reduced, steps 403 and 404 are repeated, as indicated by the arrow between steps 404 and 403, until the noise signal returns to a normal level or at least falls below a defined threshold. Another termination criterion within the scope of the present disclosure may be that the voltage or current has reached the maximum possible value that the system can provide. In a sixth step 406, the charging process is completed according to FIG. 4. Since the oscillation or vibration excitations are also stopped at this moment, in the seventh step 407 the heating element 32 can be switched off again, and the rotation rate sensor is then back in normal operation 408.

Instead of observing the noise at the end of the signal path, the modulation of the amplifier stages can be monitored in the upstream amplifier stages of the integrated switching element 20 of the rotation rate sensor. In a capacitively detecting rotation rate sensor, the amplifier stages can, for example, be a capacitance-to-voltage converter and/or an analog-to-digital converter of an evaluation circuit. The heating element 32 can already be activated when a significantly increased modulation of the amplifier stages builds up, even though there is not yet a significant increase in noise at the sensor output. A significant increase in noise or in the offset generally only occurs when at least one of the amplifier stages is heavily overdriven, causing the input signal to exceed the maximum permissible range. By monitoring the modulation of the amplifier stages and applying heat at a very early stage, the occurrence of significantly increased noise or offset can be completely prevented, or at least the duration of its occurrence can be minimized.

The above-mentioned method steps according to the present disclosure can be triggered by the rotation rate sensor according to the present disclosure. However, it is also conceivable that a main processor of the smartphone containing the rotation rate sensor triggers this. In the first case, a microprocessor integrated into the rotation rate sensor or IMU would perform the steps shown in FIG. 4. Alternatively, the procedure according to the present disclosure could be started externally.

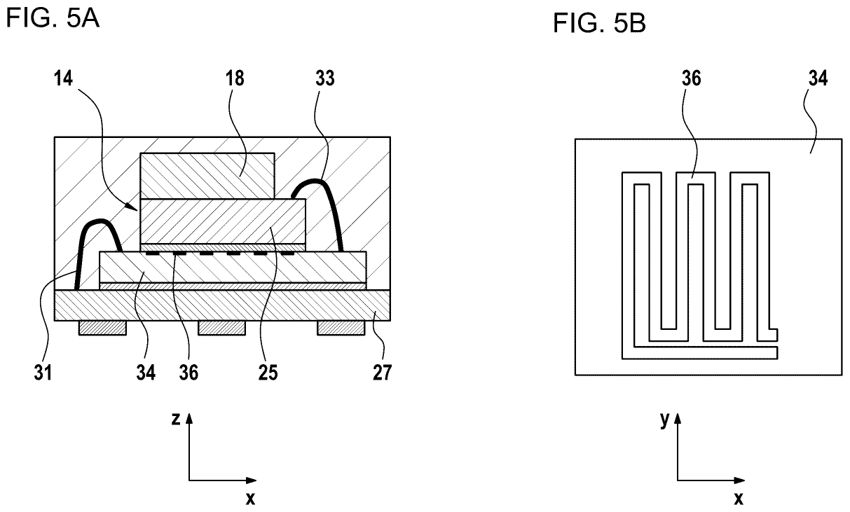

A second exemplary embodiment of the heating element used in the first embodiment of the rotation rate sensor according to the present disclosure is arranged as shown in FIGS. 5A and 5B in or on an integrated switching element 34, for example as an ASIC, in particular as a resistance meander or resistance spiral 36 in an upper metal layer. Such an arrangement according to FIG. 5A is advantageous when the MEMS chip 14 is arranged on the integrated switching element 34 and connected to it with bonding wires 33. Bonding wires 31 connect the housing substrate 27 to the integrated switching element 34. In this case, the heat generated by the heating element 36 can be transported very effectively into the MEMS chip 14. In the arrangement of the MEMS chip 14 and ASIC 34 according to FIG. 2A, the heat transport from the integrated switching element to the MEMS chip would however be less effective.

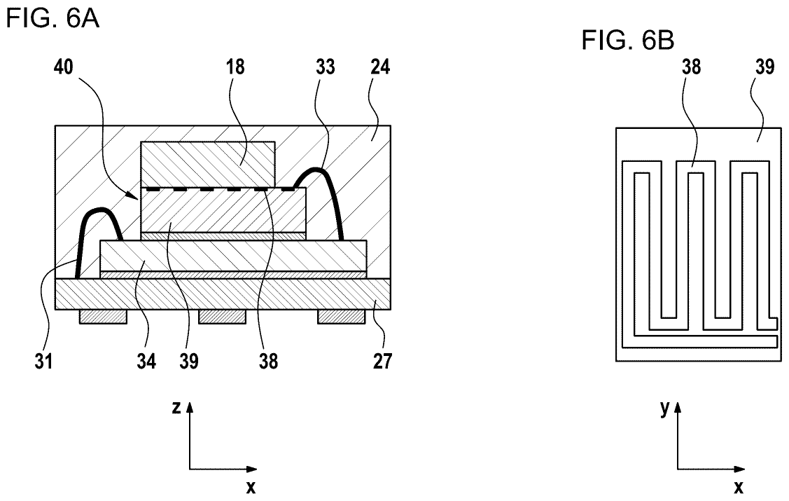

A third exemplary embodiment of a heating element 38 used in the first embodiment of the rotation rate sensor according to the present disclosure is arranged on a substrate 39 of a MEMS chip 40; see FIG. 6A. Here too, a resistance meander 38 is used as a heating element, which can be formed in a wiring plane from polysilicon using conventional surface micromechanical methods and is located directly below the movable structure of the rotation rate sensor. The heating element 38 can then be supplied with voltage or current via a dedicated output on the integrated switching element 34 and a dedicated input on the MEMS chip 40, which are connected by a bonding wire or by two bonding wires 31, 33.

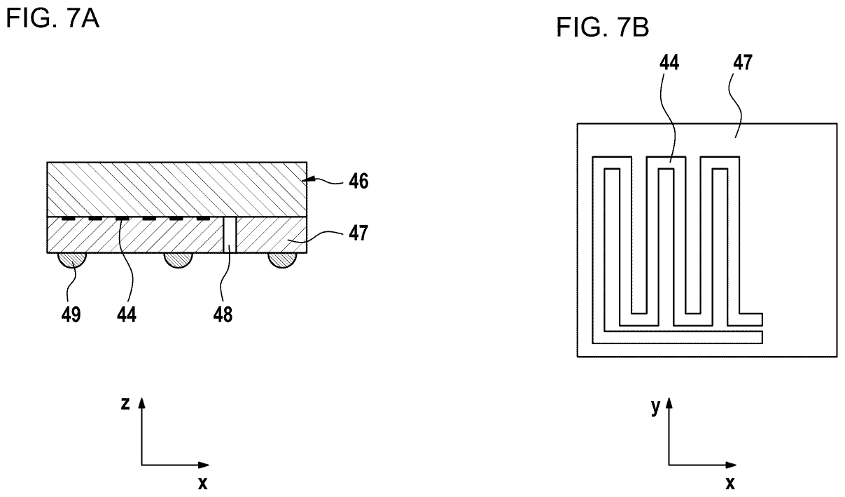

A fourth exemplary embodiment of a heating element 44 used in the first embodiment of the rotation rate sensor according to the present disclosure is arranged in a cap of a MEMS element or MEMS chip 46 according to FIG. 7A. This embodiment is particularly advantageous when an integrated switching element 47 designed as a functional application-specific integrated circuit (ASIC) is used as the MEMS cap; see FIG. 7A. Here the MEMS element 46 and the ASIC 47 are electrically connected to each other via electrical contacts 48 which are formed during wafer bonding. The electrical signals of the ASIC 47 are routed via electrical through-contacts 48 through the ASIC substrate to the outside of the ASIC, where solder contacts 49 are located for circuit board mounting. Since the metal conductor tracks of the ASIC 47, from which the heating element 44 is formed, are arranged very close to the MEMS functional structures, in this embodiment a temperature increase in the MEMS structure 46 is possible that is very effective, i.e. requires extremely little heating power.

The aforementioned embodiments according to the present disclosure can either be triggered by the rotation rate sensor itself, i.e. as it were autonomously, or externally, for example by the main processor of the smartphone. In the first case, a microprocessor integrated into the rotation rate sensor or IMU would perform steps 401 to 408 as shown in FIG. 4, without the need for the manufacturer of the electronic device to take any action. Alternatively, the procedure according to the present disclosure could be started externally. When using a heating element in the housing substrate, it would be plausible to supply the heating current to the sensor via an external source.

In the second, third and fourth embodiments, in contrast, the sensor itself will provide the heating voltage or heating current. Hybrid forms are also conceivable in which the increased noise is detected externally, but the heating voltage or heating current is generated internally in the ASIC of the rotation rate sensor.

The above-mentioned exemplary embodiments of the present disclosure for increasing the temperature are all associated with increased electricity or energy consumption. However, the additional power required to operate the heating element is at most in the milliwatt range compared to the power supplied by the charger during the charging process of the consumer electronics device (watt range). For an end user of the consumer electronics device, this results merely in a generally imperceptible increase in charging time.

According to a second embodiment of the method according to the present disclosure, the position of the interference mode is shifted by changing the drive amplitude of the rotation rate sensor. A change in the drive amplitude can be achieved easily via the control electronics of the rotation rate sensor by setting a different target value for the automatic amplifier control. Since the sensor is generally operated at the highest possible drive amplitudes to achieve a good signal-to-noise ratio, setting a reduced drive amplitude is advisable. Depending on the type of parasitic mode, a change in the drive amplitude of the rotation rate sensor can have a significant influence on the eigenfrequency of the parasitic mode, since there can be nonlinear couplings between the drive mode and parasitic modes. For some parasitic modes, reducing or generally changing the drive amplitude can therefore lead to sufficiently large frequency changes in the parasitic mode to eliminate or at least significantly reduce the signal interference at the sensor output when vibration is excited.

However, the method of drive amplitude reduction according to the present disclosure can also lead to a positive effect in the signal path in the case of parasitic modes of which the eigenfrequency is not, or is hardly, affected by the drive amplitude. Although the parasitic mode is then mechanically decoupled from the drive mode, a displacement-capacitance conversion, i.e. deflection movements of the drive mode and the parasitic mode into capacitance changes, can lead to nonlinear superposition of signal components in the electrostatic system. Such a nonlinear superposition can be directly derived from the relationship C~ 1/(d+z) between detection capacitance C and deflection z in a plate capacitor with a base distance d. Even the drive movement can have an interference component in the detection direction, which is referred to as quadrature. The amplitude of the quadrature movement is proportional to the drive amplitude. If the quadrature movement is superimposed with movement components of the vibration-induced parasitic mode, capacitive detection signals, in particular their interference components, will depend not only on the amplitude of the parasitic mode but also on the size of the quadrature movement. A reduction of quadrature movement, achieved by reducing the drive amplitude, can therefore lead to an effective reduction of the overall signal interference. In addition, depending on the sensor design, so-called 2f quadrature signals can also occur, i.e., interference signals that lead to signal components with twice the drive frequency in the detection path. These generally depend quadratically on the drive amplitude. A reduction in the drive amplitude then leads to a particularly significant reduction in the overall modulation of the detection path and thus possibly to an effective reduction in the overall signal interference.

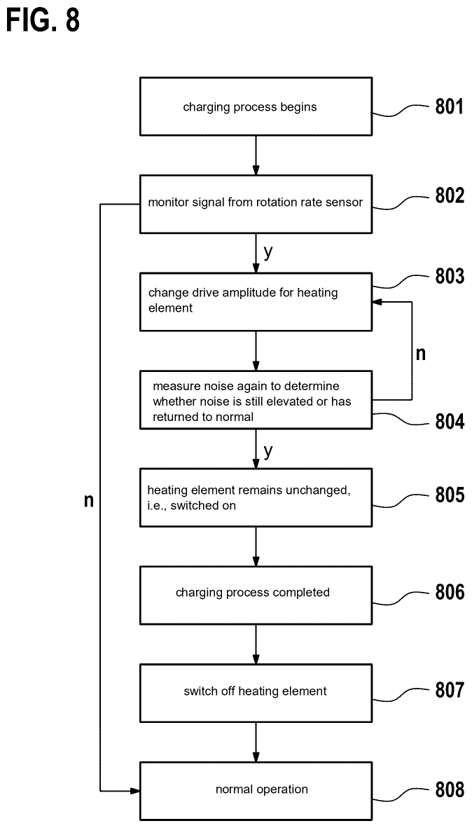

The second embodiment of the method according to the present disclosure, using a change in the working amplitude to reduce vibration-induced interference signals, is shown as a flowchart in FIG. 8 with steps 801-808 and can be applied analogously to the flowchart of FIG. 4, wherein instead of changes in the voltage U or current I, changes in the drive amplitude, preferably step-by-step reductions in the working amplitude, are made in this case, as shown in step 803. In accordance with the method illustrated by FIG. 4, steps 803 and 804 are also repeated, as indicated by the arrow between step 804 and 803, until the noise signal is back to normal level or at least below a defined threshold. Since the analog useful signal of the sensor decreases proportionally to the drive amplitude, the digital gain of the sensor should be appropriately increased in the individual steps of the drive amplitude reduction in order to keep the sensitivity which results from the product of the analog useful signal and the digital gain at the same level.

According to a third embodiment of the inventive method of the present disclosure, so-called electrostatic spring softening is used to reduce vibration-induced interference signals. The basic idea here is that the frequency position of the relevant parasitic mode can be changed by applying electrical voltages to plate-capacitor-like structures in the micromechanical rotation rate sensor. This method will typically be used with capacitively detecting rotation rate sensors.

For the sake of completeness, the principle of electrostatic spring softening will be briefly explained again here. An electrostatic force in the z-direction in a plate capacitor with a base capacitance C₀, across which a voltage U is applied, is given by

$${F}_{e 1} = \frac{1}{2} \frac{{dC}_{0}}{dz} {U}^{2} .$$

For a mechanical oscillator with an electrode movable in the z-direction, the total force for the mechanical oscillator results not only from a mechanical restoring force −k*z, but also from the electrostatic force, i.e.

$${F}_{ges} = - kz + \frac{1}{2} \frac{{dC}_{0}}{dz} {U}^{2} .$$

An effective spring stiffness k_{eff} is then formally obtained by differentiating with respect to the deflection, yielding:

$${k}_{eff} = - \frac{{dF}_{ges}}{dz} = k - \frac{1}{2} \frac{{d}^{2} {C}_{0}}{{dz}^{2}} {U}^{2} .$$

For a plate capacitor with a 1/z distance law, the second derivative d²C₀/dz² is positive, so that the voltage-dependent additional contribution in the last equation always leads to a reduction in the spring stiffness.

In an exemplary embodiment of the third embodiment of the method according to the present disclosure for operating a rotation rate sensor, the detection electrodes used for rotation rate detection form the plate capacitor and the voltage U is changed between the moving sensor mass and the detection electrodes. The voltage U can be a constant bias voltage, but it can also be a pulsed voltage or a superposition of a bias voltage with alternating voltage components. Changing the effective voltage between the moving sensor mass and the detection electrodes influences the frequency position of the detection mode, but also, again depending on the type of parasitic mode, the frequency position of the parasitic mode. If the parasitic mode can be significantly influenced by the electrostatic spring softening, it can be pushed out of the critical range for vibration excitation, for example by a step-by-step increase or decrease of the effective voltage.

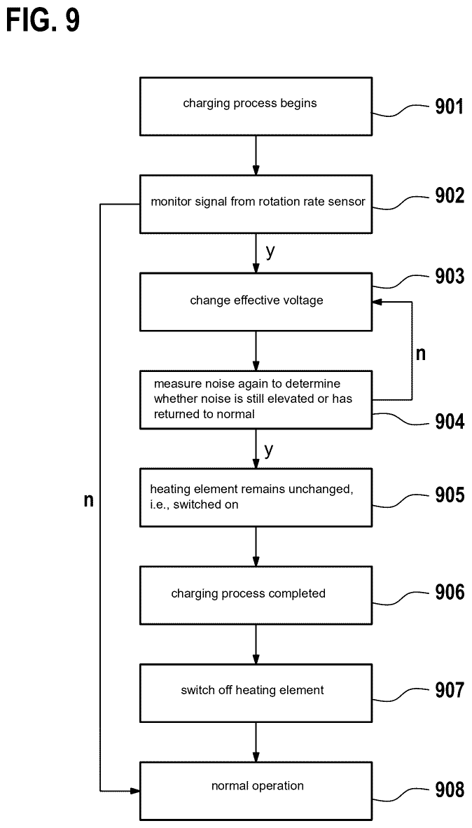

The method according to the present disclosure with a change in the electrostatic spring softening to reduce oscillation- or vibration-induced interference signals is illustrated by the flowchart in FIG. 9, with steps 901-908. The method is preferably applied analogously to those shown in the flowcharts of FIGS. 4 and 8. In this case, changes in the effective voltage, preferably reductions in the effective voltage, are made between the movable sensor structure and the detection electrodes, as shown in step 903.

In a further exemplary embodiment of the third embodiment of the method according to the present disclosure for operating a rotation rate sensor, dedicated electrodes are used for the electrostatic spring softening, i.e. electrodes that are not used for rotation rate sensing. On the one hand, at least if the relevant parasitic mode has a known form, additional electrodes can be placed where they can produce the greatest possible effect of electrostatic spring softening for the parasitic mode. On the other hand, the effective voltage at the moving mass remains unchanged, so that there is no significant shift in the operating point of the rotation rate sensor.

In yet a further exemplary embodiment of the third embodiment of the method according to the present disclosure for operating a rotation rate sensor, electrodes that are already present but are not used for rotation rate detection are used for the electrostatic spring softening. These can be, for example, test electrodes via which electrostatic forces can be applied to the micromechanical structure, e.g. an electrostatic quadrature force, in order to enable checking of the function and sensitivity of the sensor during operation. Alternatively, they can be electrodes for compensating for the quadrature.

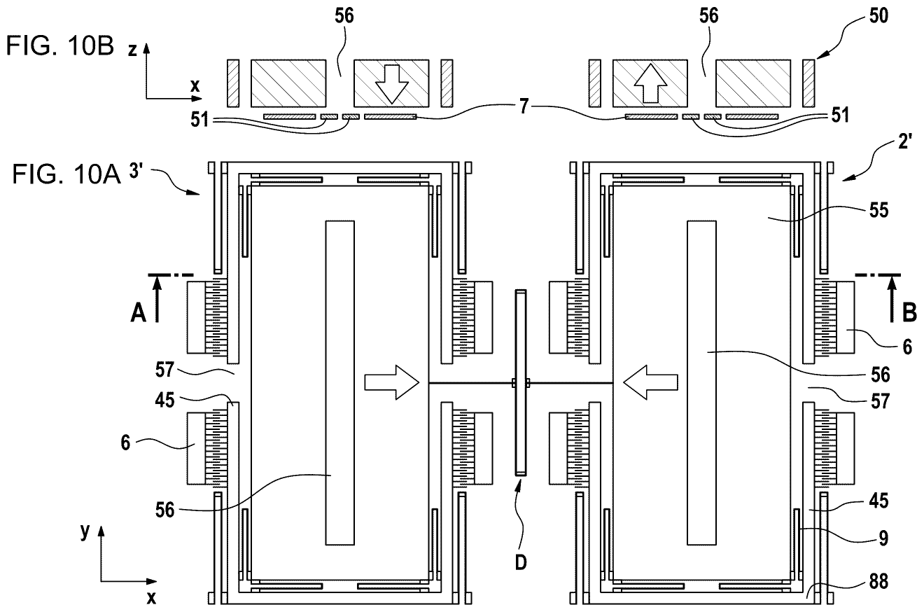

FIGS. 10A and 10B show a rotation rate sensor 50 based on the arrangement of FIGS. 1A and 1B according to the present disclosure, which contains additional electrodes 51 for compensating for the quadrature, or alternatively for generating quadrature signals. For this purpose, an inner detection mass element 55 has a wide slot 56 and an outer mass element 45 is constructed in two parts, forming an open space 57. The electrodes 51 are arranged below the slot 56 (FIG. 10A), but still partially overlapping with the inner detection mass element 55. The electrodes 51 for compensating for the quadrature generally have two electrically separated arrangements, a first of which is used to compensate for positive quadrature values and a second of which is used to compensate for negative quadrature values. For this purpose, suitable electrical voltages Uₚ, Uₙ can be applied to the arrangements. During operation, normally only one of the arrangements is subjected to a voltage to compensate for the quadrature. If the voltage on both arrangements is now increased such that the quadrature compensation forces remain unchanged, by keeping the difference in the squares of the voltages Uₚ²-Uₙ² constant while the sum of the squared voltages Uₚ²+Uₙ² is increased, an electrostatic spring softening can be achieved in addition to the quadrature compensation effect.

If the electrodes 51 for compensating for the quadrature are provided such that the electrostatic spring softening has a significant influence on the parasitic mode, the eigenfrequency of the parasitic mode can be pushed out of the critical range for vibration excitation by a suitable increase in the voltages Uₚ, Uₙ. The increased values for the sum of the squared voltages Uₚ²+Uₙ² can also have a certain influence on the effective stiffness of the detection mode and thus on the electrical sensitivity of the rotation rate sensor 50. However, this effect can be measured, for example, during the final test and calibration of the sensor 50 and then compensated for during the application of the process sequence according to FIG. 4 by a targeted adjustment of the digital gain of the sensor.

Within the scope of the present disclosure, a change in temperature, a change in drive amplitude and a change in the electrostatic spring softening can be combined in a suitable manner to reduce the vibration-induced interferences. Thus, as shown in FIG. 4, first the temperature can be increased. If the vibration-induced noise of the rotation rate sensor is not sufficiently reduced even at the maximum available heating voltage, in addition the drive amplitude can be reduced and/or the electrostatic spring softening can be changed to achieve a sufficiently low noise level.

### LIST OF REFERENCE SIGNS

| | |
|---|---|
| 1 | Rotation rate sensor (related art) |
| 2, 2′ | Structure |
| 3, 3′ | Structure |
| 4 | Outer mass element |
| 5 | Inner mass element |
| 6 | Comb electrode |
| 7 | Detection electrode |
| 8 | Drive frame |
| 9 | Spring |
| P1, P2 | Direction of rotation |
| D | Axis of rotation |
| 12 | MEMS chip |
| 14 | MEMS chip |
| 16 | Cap wafer |
| 18 | Cap wafer |
| 20 | ASIC |
| 22 | ASIC |
| 24 | Injection housing |
| 21, 25 | MEMS substrate |
| 26 | Adhesive |
| 27 | Housing substrate |
| 27a, b | Top and bottom side of 27 |
| 28 | Adhesive |
| 29, 30, 31, 33 | Bonding wire |
| 32, 36, 38, 44 | Heating element |
| 34 | ASIC |
| 39 | MEMS substrate |
| 40, 46 | MEMS chip |
| 45 | Outer mass element |
| 47 | ASIC |
| 48 | Electrical contact |
| 49 | Solder contact |
| 50 | Rotation rate sensor |
| 51 | Compensation electrodes |
| 55 | Inner mass element |
| 56 | Slot |
| 57 | Open space |
| 88 | Divided drive frame |
| 401-408 | Method steps |
| 801-808 | Method steps |
| 901-908 | Method steps |

What is claimed is:

1. A rotation rate sensor, comprising:
a drive mass element arranged above a surface of a substrate which can be driven by a drive device to oscillate along a first axis running along the surface;
a detection mass element which can be deflected along a second axis by an action of a Coriolis force; and
a detection device by which the deflection of the detection mass element along the second axis can be detected, wherein the second axis runs perpendicularly to the first axis; and
a device configured to frequency-shift an interference mode of the rotation rate sensor to reduce noise or to reduce offset jumps.

2. The rotation rate sensor according to claim 1, wherein the device configured to frequency-shift the interference mode is a heating element.

3. The rotation rate sensor according to claim 2, wherein a housing accommodates the drive mass element and the detection mass element, configured as a microelectromechanical structure (MEMS) with an associated integrated switching element, and wherein the heating element is provided as a resistance line in a metal plane of a substrate of the housing.

4. The rotation rate sensor according to claim 2, wherein a housing accommodates the drive mass element and the detection mass element, configured as a microelectromechanical structure (MEMS) with an integrated switching element, and the heating element is provided in or on the integrated switching element.

5. The rotation rate sensor according to claim 4, wherein the integrated switching element is an application-specific integrated circuit (ASIC), and the heating element is a resistance line in a metal layer of the integrated circuit.

6. The rotation rate sensor according to claim 2, wherein a housing accommodates the drive mass element and the detection mass element, configured as a microelectromechanical structure (MEMS) with an associated integrated switching element, and the heating element is provided on a substrate of the microelectromechanical structure (MEMS).

7. The rotation rate sensor according to claim 6, wherein the heating element is provided in a wiring plane below a movable structure of the rotation rate sensor.

8. The rotation rate sensor according to claim 2, wherein the drive mass element and the detection mass element are configured as a microelectromechanical structure (MEMS), an integrated switching element is assigned to the microelectromechanical structure (MEMS) as a cap, and the heating element is provided in the cap of the microelectromechanical structure.

9. The rotation rate sensor according to claim 1, wherein a structure of the rotation rate sensor is micromechanical, and the detection device is configured as detection electrodes which form a plate capacitor, and a voltage between the detection electrodes and the detection mass element can be varied to adjust an electrostatic spring softening.

10. The rotation rate sensor according to claim 1, wherein a structure of the rotation rate sensor is micromechanical, and existing electrodes not used for rotation rate detection or additional electrodes, form a plate capacitor, and a voltage between the existing electrodes or the additional electrodes, and the detection mass element, can be varied to adjust an electrostatic spring softening.

11. A method for operating a rotation rate sensor, the rotation rate element including:
a drive mass element arranged above a surface of a substrate which can be driven by a drive device to oscillate along a first axis running along the surface,
a detection mass element which can be deflected along a second axis by an action of a Coriolis force, and
a detection device by which the deflection of the detection mass element along the second axis can be detected, wherein the second axis runs perpendicularly to the first axis, and
a device configured to frequency-shift an interference mode of the rotation rate sensor to reduce noise or to reduce offset jumps;
wherein the rotation rate sensor is micromechanically constructed,
the method comprising the following steps:
exciting the detection mass element to oscillate along a first direction;
detecting a Coriolis deflection of the detection mass element along a second direction, which is perpendicular to the first direction, using the detecting device;
measuring noise in the rotation rate sensor;
based on increased noise, changing operating parameters to cause a frequency shift of an interference mode.

12. The method according to claim 11, wherein the frequency shift of the interference mode is caused by a local temperature increase.

13. The method according to claim 11, wherein the frequency shift of the interference mode is caused by a change in a drive amplitude.

14. The method according to claim 11, wherein the frequency shift of the interference mode is caused by an electrostatic spring softening.
